(19) United States
(12) Patent Application Publication
(10) Pub. No.: US 2025/0010536 A1
(43) Pub. Date: Jan. 9, 2025

(54) TOOLING ASSEMBLY FOR FORMING A CONTAINER BY BLOW MOLDING

(71) Applicant: AMCOR RIGID PACKAGING USA, LLC, Ann Arbor, MI (US)

(72) Inventors: Lauren STRAPEC, Dexter, MI (US); Michael T. LANE, Brooklyn, MI (US); James STELZER, South Lyon, MI (US); Luke A. MAST, Brooklyn, MI (US)

(21) Appl. No.: 18/705,671

(22) PCT Filed: Nov. 3, 2021
(86) PCT No.: PCT/US2021/072213

§ 371 Date: Apr. 29, 2024

(51) Int. Cl. B29C 49/06; B29C 49/28; B29C 49/32; B29C 49/48; B29C 49/56; B29L 31/00

(52) U.S. Cl. CPC B29C 49/06; B29C 49/28008; B29C 49/32; B29C 49/4802; B29C 49/5606; B29C 2049/4807; B29C 2049/4858; B29C 2049/5661; B29K 2905/02; B29K 2905/12; B29K 2995/0094; B29L 2031/712

(57) ABSTRACT

A base assembly configured to cooperate with an injection blow molding machine for forming a polymeric container from a preform by injection blow molding. The base assembly includes a base insert defining a base mold configured to form a base of the polymeric container during injection blow molding. The base insert is slidably seated within the base assembly. The base insert is slidably movable between a retracted position and an extended position during injection blow molding of the polymeric container.

### FIELD

The present disclosure relates to a tooling assembly for a blow molding machine configured to form a container from a preform by blow molding.

### BACKGROUND

This section provides background information related to the present disclosure, which is not necessarily prior art.

Polymeric containers are often formed by injection molding a preform using an injection molding machine, and then blow molding the preform into the final container using a blow molding machine. This process is known as 2-step injection stretch blow molding or simply injection blow molding. The machine includes one or more assemblies, each of which have a container mold that the preform is blow molded into. While existing assemblies are suitable for their intended use, they are subject to improvement. For example, an assembly that is shorter, lighter, and has fewer parts than existing assemblies would be desirable. The present disclosure advantageously addresses various needs in the art, as explained herein and as one skilled in the art will appreciate.

### SUMMARY

This section provides a general summary of the disclosure, and is not a comprehensive disclosure of its full scope or all of its features.

The present disclosure includes a base assembly configured to cooperate with an injection blow molding machine for forming a polymeric container from a preform by injection blow molding. The base assembly includes a base insert defining a base mold configured to form a base of the polymeric container during injection blow molding. The base insert is slidably seated within the base assembly. The base insert is slidably movable between a retracted position and an extended position during injection blow molding of the polymeric container.

The present disclosure further includes an assembly configured to cooperate with an injection blow molding machine for forming a polymeric container from a preform by injection blow molding. The assembly has a pedestal and a guiding ring supported by the pedestal. A base insert is slidably seated within the guiding ring. The base insert defines a base mold configured to form a base of the polymeric container during injection blow molding. An outer base cup is arranged above the guiding ring. The base insert is slidably seated within the outer base cup. A body mold is configured to form a body of the polymeric container. The body mold includes a first half and a second half and defines an internal flange facing an upper surface of the outer base cup when the body mold is closed during injection blow molding. The internal flange is a horizontal mold parting line extending perpendicular to a longitudinal axis of the assembly passing through an axial center of the base insert and the outer base cup. The base insert is slidably movable independent of the pedestal, the guiding ring, and the outer base cup.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a perspective view of a mold assembly in accordance with the present disclosure for a container blow molding machine;

FIG. 2 is a plan view of a bottom of the assembly of FIG. 1;

FIG. 3 is a cross-sectional view of the assembly of FIG. 1;

FIG. 4 is a cross-sectional view of the assembly of FIG. 1 with a base insert in an extended position;

FIG. 5 is a cross-sectional view of the assembly of FIG. 1 with the base insert in a retracted position;

FIG. 6 is a perspective view of the assembly of FIG. 1 with the base insert in the retracted position and a stretch rod in an extended position;

FIG. 7 is a perspective view of the assembly of FIG. 1 with the base insert in the extended position and the stretch rod in the extended position;

FIG. 8A illustrates a mold window of the mold assembly accommodating a relatively short body mold;

FIG. 8B illustrates the mold window accommodating a relatively tall body mold.

Corresponding reference numerals indicate corresponding parts throughout the several views of the drawings.

### DETAILED DESCRIPTION

Example embodiments will now be described more fully with reference to the accompanying drawings.

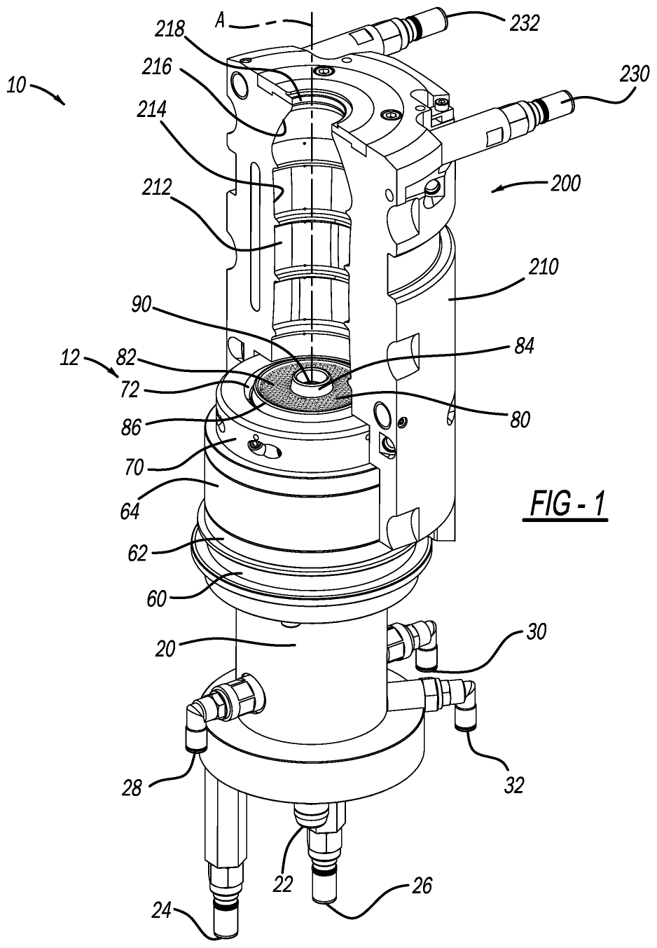

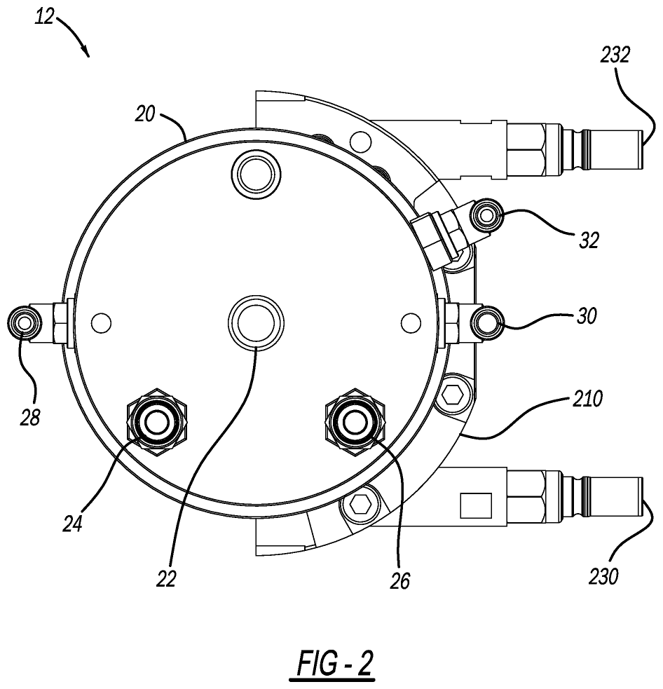

With initial reference to FIGS. 1-3, a mold assembly in accordance with the present disclosure is illustrated at reference numeral 10. The mold assembly 10 is configured to cooperate with an injection blow molding machine, which is operable to form a polymeric container from a preform by injection blow molding. Examples of suitable blow molding equipment include the Sidel Universal™ and Sidel Matrix™ machines. The preform and container formed therefrom may be made of any suitable polymeric material, such as, but not limited to, the following: polyethylene terephthalate (PET), low-density polyethylene (LDPE), high-density polyethylene (HDPE), polypropylene (PP), polystyrene, and the like, for example. The container may have any suitable shape, size, and capacity. For example the container may have a capacity of 10 to 32 ounces. The containers may be formed with any suitable base. Exemplary bases include, but are not limited to, flexible bases including a center push-up portion configured to move inward in response to a vacuum formed within the container as it is filled. Exemplary container bases and production methods include, but are not limited to, the bases disclosed in following U.S. patents, which are incorporated by reference herein in their entirety: U.S. Pat. No. 8,313,686 (issued Nov. 20, 2012); U.S. Pat. No. 10,232,545 (issued Mar. 19, 2019); U.S. Pat. No. 9,833,938 (issued Dec. 5, 2017); U.S. Pat. No. 9,617,029 (issued Apr. 11, 2017); U.S. Pat. No. 9,694,930 (issued Jul. 4, 2017); and U.S. Pat. No. 9,422,076 (issued Aug. 23, 2016). The polymeric container formed using the assembly 10 may be configured for being hot-filled or cold-filled with any suitable commodity. Exemplary suitable commodities include, but are not limited to, carbonated soft drinks (CSD), water, sport drinks, food stuffs, etc.

The mold assembly 10 generally includes a base assembly 12 and a body assembly 200. The base assembly 12 includes a pedestal 20, a counter stretch rod 50, a locking ring 60, a spacer 62, a guiding ring 64, an outer base cup 70, and a base insert 80. The main components of the base assembly 12 may be made of any suitable material, such as aluminum, stainless steel, or titanium, for example.

A quick-change support post 22 extends from a bottom surface of the pedestal 20. The quick-change support post 22 is configured to mount the base assembly 12 in various different injection blow molding machines. Thus advantageously, the base assembly 12 may be installed within various different blow molding machines based on manufacturing needs and preferences. The base assembly 12 may also be swapped out of a particular machine should the base assembly 12 need repairs, and then replaced with a different similar assembly to reduce downtime of the injection blow molding machine.

The pedestal 20 includes an oil inlet 24 and an oil outlet 26 through which oil is pumped into and out of the pedestal 20 during operation of the injection blow molding machine. The pedestal 20 includes a gas inlet 28 and a gas outlet 30 for the introduction of air or another suitable gas into and out of the base assembly 12, such as for actuating a base insert 80 as described further herein. A gas inlet/outlet 32 of the pedestal 20 allows for the introduction of air, or some other suitable gas, into and out of the base assembly 12 to actuate a counter stretch rod 50, as described further herein. The pedestal 20 defines passages from each of the inlets/outlets 24, 26, 28, 30, and 32 to various locations within the pedestal 20 to conduct gas and oil where needed. The pedestal 20 defines a center chamber 40 in which the counter stretch rod 50 is seated. Arranged on the counter stretch rod 50 is one or more seals 52. In other embodiments, the counter stretch rod 50 can be moved hydraulically or with a servo. In still other embodiments, the counter stretch rod 50 may not be required to form the container base and therefore may not be included in the base assembly 12.

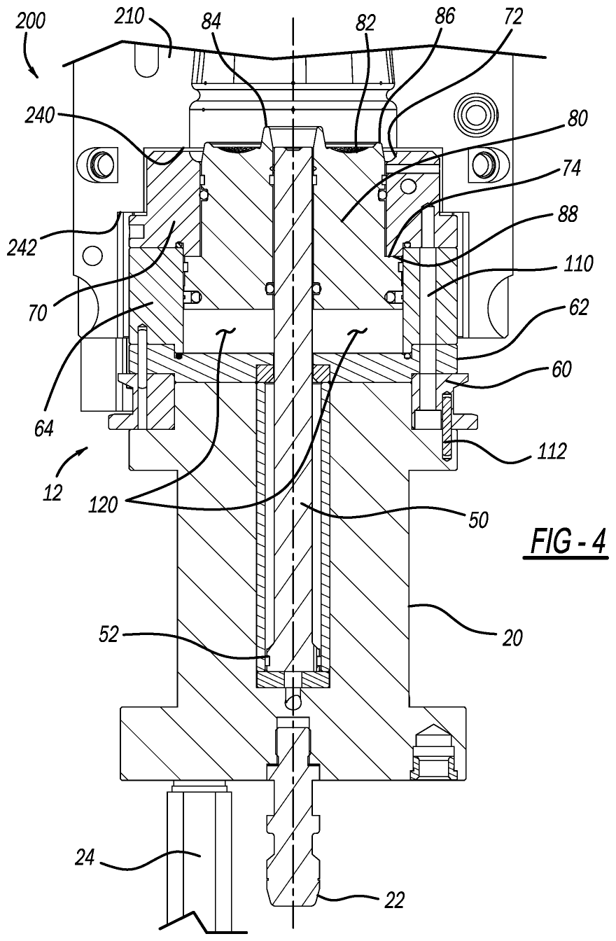

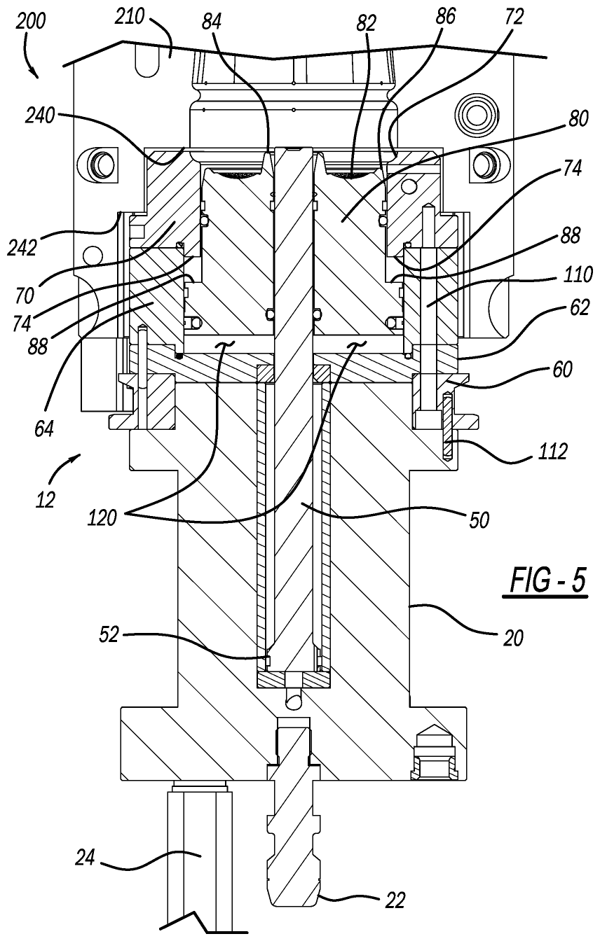

With continued reference to FIGS. 1-3, and additional reference to FIGS. 4 and 5, seated on the pedestal 20 is a locking ring 60. The locking ring 60 includes one or more flanges configured to cooperate with a body mold 210 of the body assembly 200 when two halves of the body mold 210 are closed and a preform seated therein is injection blow molded into a container. Seated on the locking ring 60 and the pedestal 20 is a spacer 62. Each one of the locking ring 60 and the spacer 62 define a center aperture through which the counter stretch rod 50 extends.

Seated on the spacer 62 is a guiding ring 64, and seated on the guiding ring 64 is an outer base cup 70. Each one of the guiding ring 64 and the outer base cup 70 have an annular shape with a hollow center. The hollow center is sized and shaped to slidably receive a base insert 80 therein.

The base insert 80 defines a base mold 82 at a top surface thereof. The base mold 82 is configured to form a base of the polymeric container during injection blow molding. The base mold 82 includes a center forming portion 84, which may be configured to form a center push-up portion of the base. At an outer perimeter of the base mold 82 is an outer flange 86. The outer base cup 70 defines an annular inner curved surface 72, which is adjacent to the outer flange 86. The outer flange 86 together with the annular inner curved surface 72 define a heel of the container base during blow molding and form a horizontal mold split line where the outer base cup 70 meets the two halves of the body mold 210.

The base insert 80 defines a center aperture 90 extending therethrough. The center aperture 90 is aligned with the center chamber 40 of the pedestal 20 along a longitudinal axis A of the base assembly 12. A center opening of the spacer 62 is also aligned along the longitudinal axis A. The counter stretch rod 50 is seated within the center aperture 90.

The body assembly 200 includes the body mold 210, of which only one-half thereof is illustrated. The second half of the body mold 210 is generally similar to the half that is illustrated. The body mold 210 is a clam-shaped mold that is opened and closed during the injection blow molding process. The body mold 210 generally includes an inner profile 212 with a body portion 214 for forming a body of the polymeric container during blow molding. The body 214 may have any suitable shape and size, and may define one or more ribs as appropriate. A shoulder portion 216 forms a shoulder of the container, and an upper portion 218 is configured to cooperate with a preform flange for supporting the preform. The body mold 210 further includes connectors 230 and 232. The connectors 230 and 232 are configured for heating the body mold 210 with oil. The longitudinal axis A extends through an axial center of the body mold 210 and the base mold 82.

With continued reference to FIGS. 1-3, and additional reference to FIGS. 4 and 5, movement of the base insert 80 will now be discussed. During blow molding, air or other gas is introduced into a gap 120 defined between the base insert 80, the guiding ring 64, and the spacer 62 by way of the gas inlet 28. As the gap 120 is pumped full of gas, the gas pushes the base insert 80 upward so that the base mold 82 extends above the outer base cup 70, as illustrated in FIG. 4. The base insert 80 is moved to the extended position of FIG. 4 at the appropriate time during the injection blow molding process in order to form the final shape of the container base. Then, gas is withdrawn from the gap 120 by way of the gas outlet 30, which causes the base insert 80 to move to the retracted position of FIG. 5. In other embodiments, the base insert 80 may be moved hydraulically or with a servo.

Thus, the base insert 80 moves up and down acting as a piston to facilitate overstroke. When the base insert 80 is in the retracted (downward) position, the preform is stretched and blown beyond a final position of the base. Then, the base insert 80 is moved upward to mold the preform into the final shape of the base. This advantageously reduces material weight, improves material distribution, and increases crystallinity in the base region.

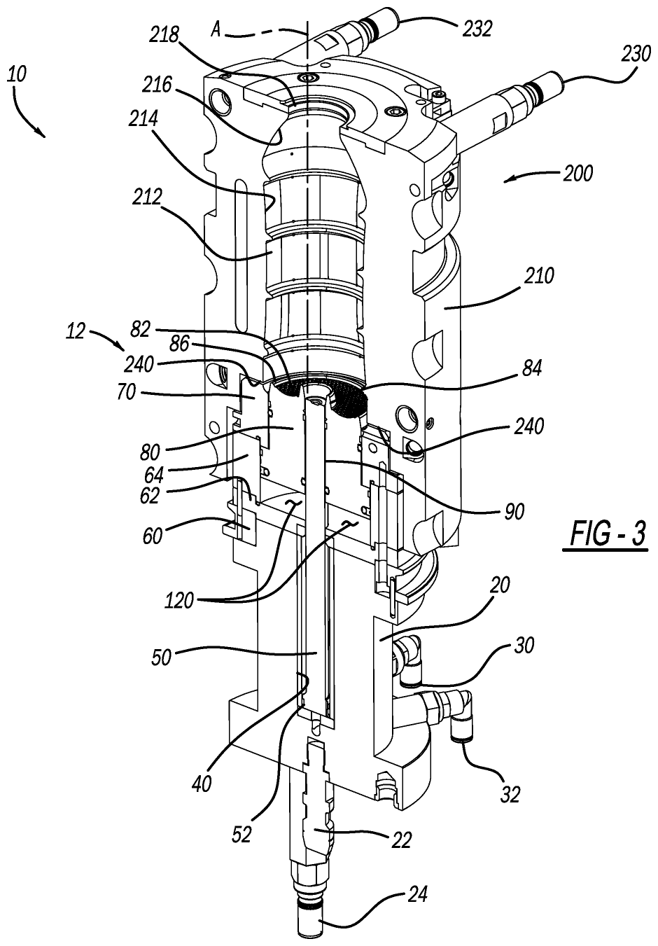

The opening of the base insert 80 defined by the center forming portion 84 allows the counter stretch rod 50 to extend out from within the base insert 80 to engage a tip of the preform as the preform is stretched and blown in order to keep the preform centered. Various seal rings, such as the seal 52, are arranged on the counter stretch rod 50 to seal off the counter stretch rod 50 and prevent passage of air. As the preform is stretched into the inner profile 212, the counter stretch rod 50 retracts back into the base insert 80 into the position of FIG. 3.

Once the preform is seated in the body mold 210, both halves of the body mold 210 are closed, which brings the halves of the body mold 210 into cooperation with the locking ring 60. The halves of the body mold 210 clamp around the locking ring 60 to hold the components of the assembly 10 in place during blow molding. The halves of the body mold 210 each include a first internal flange 240 and a second internal flange 242. When the halves of the body mold 210 are closed, the first internal flange 240 is arranged opposite to an upper surface of the outer base cup 70. The first internal flange 240 extends horizontally and perpendicular to the longitudinal axis A. The first internal flange 240 serves as a mold parting line. Configuring the first internal flange 240 to be a horizontal flange as illustrated, advantageously minimizes flash and any possible sticking of the body mold 210 during the injection blow molding process. The horizontal first internal flange 240 is in contrast to previous mold parting lines, which have always been arranged vertically (extending parallel to the longitudinal axis A). The second internal flange 242 is arranged opposite to a lower flange of the outer base cup 70.

The locking ring 60, the spacer 62, the guiding ring 64, and the outer base cup 70 are all rigidly secured in any suitable manner, such as with bolt 110 (see FIGS. 4 and 5). The locking ring 60 is secured to the pedestal 20 by way of bolt 112, or in any other suitable manner. Thus each one of the locking ring 60, the spacer 62, the guiding ring 64, and the outer base cup 70 are rigidly secured and not movable, which is in contrast to the base insert 80.

The outer base cup 70 further includes a lower cup flange 74, which is opposite to a base flange 88 of the base insert 80. In the extended position of FIG. 4, the flange 88 abuts the lower cup flange 74, which advantageously stops the base insert 80 from moving upward beyond the extended position of FIG. 4.

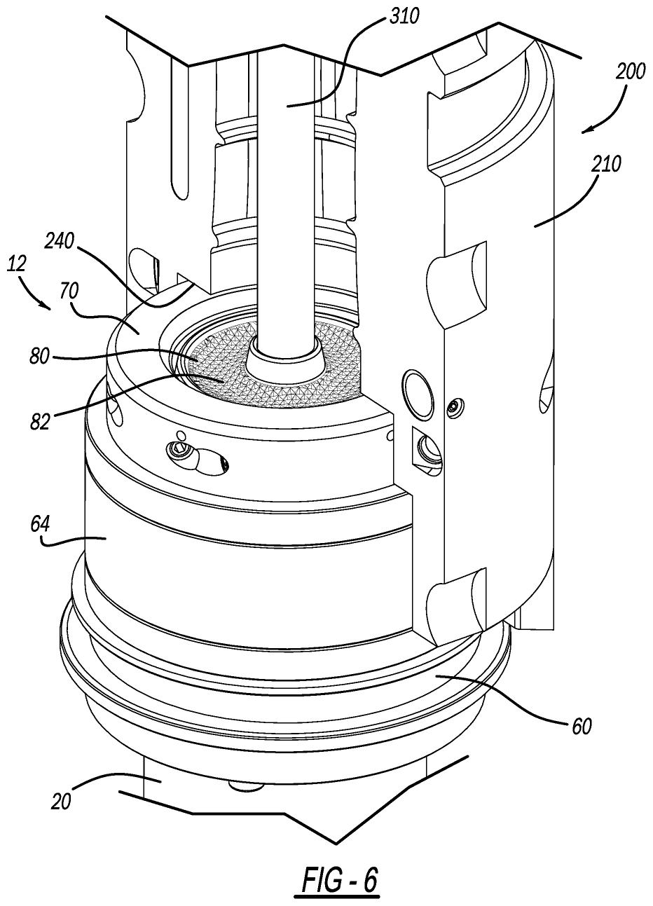

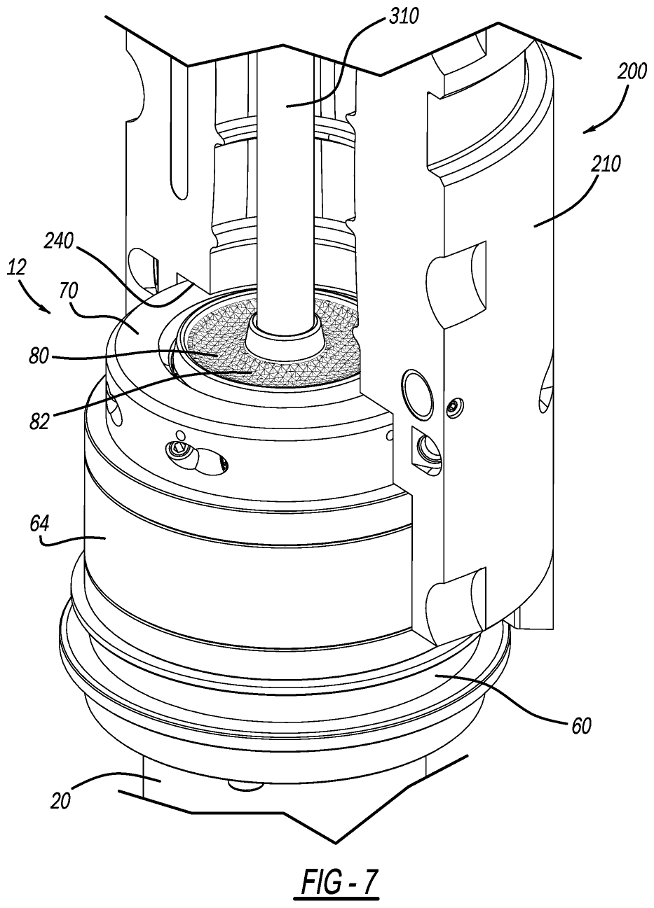

With additional reference to FIGS. 6 and 7, the assembly 10 further includes a stretch rod 310. The stretch rod 310 may define holes through which air may be pumped to advantageously cool the polymeric container during the injection blow molding process. FIG. 6 illustrates the stretch rod 310 seated within the center forming portion 84 of the base insert 80 with the base insert 80 in the low retracted position. FIG. 7 is similar to FIG. 6, but with base insert 80 in the extended position for cooperation with the preform to form the base of the polymeric container during injection blow molding.

Thus the present disclosure advantageously provides for the mold assembly 10 configured to be incorporated into a blow molding machine to form a polymeric container, and particularly a base thereof. Compared to previous assemblies, the base assembly 12 has fewer parts (such as seven main base assembly components as compared to existing assemblies, which can have ten or more base assembly components).

With reference to Table 1 below, depending on the capacity of the container and the materials used, the weight of the base assembly 12 can be between 4.9 and 35.7 pounds, and the weight of the base insert 80 can be between 0.7 and 4.1 pounds.

TABLE 1

| | 10 oz Container | | 16 oz Container | | 32 oz Container | |
|---|---|---|---|---|---|---|
| Weight (lbs) | Aluminum | Stainless | Aluminum | Stainless | Aluminum | Stainless |
| Pedestal | 4.2 (lbs.) | 11.9 (lbs.) | 8.4 (lbs.) | 23.8 (lbs.) | 12.6 (lbs.) | 35.7 (lbs.) |
| Base Cup | | | | | | |
| Spacer | | | | | | |
| Guide Ring | | | | | | |
| C.S.R. | | | | | | |
| Lock Ring | | | | | | |
| Base Insert | 0.7 (lbs.) | 2.0 (lbs.) | 0.9 (lbs.) | 2.6 (lbs.) | 1.4 (lbs.) | 4.1 (lbs.) |
| Total Weight | 4.9 (lbs.) | 13.9 (lbs.) | 9.3 (lbs.) | 26.4 (lbs.) | 14.0 (lbs.) | 39.8 (lbs.) |

With reference to Table 2 below, depending on the capacity of the container, the volume of the base assembly 12 can be between 43.8 and 124.4 cubic inches, and the volume of the base insert 80 can be between 7.1 and 14.2 cubic inches. Therefore, the volume of the base insert 80 is less than 20% of a total weight of the base assembly 12, or about 11-16% of a total weight of the base assembly 12.

TABLE 2

| | 10 oz | | 16 oz | | 32 oz | |
|---|---|---|---|---|---|---|
| | Container | | Container | | Container | |
| | Volume (in³) | | Volume (in³) | | Volume (in³) | |
| Pedestal | 36.7 | (in³) | 73.5 | (in³) | 110.2 | (in³) |
| Base Cup | | | | | | |
| Spacer | | | | | | |
| Guide Ring | | | | | | |
| C.S.R. | | | | | | |
| Lock Ring | | | | | | |
| Base Insert | 7.1 | (in³) | 8.9 | (in³) | 14.2 | (in³) |
| Total Weight | 43.8 | (lbs.) | 82.4 | (lbs.) | 124.4 | (lbs.) |

| | | | |
|---|---|---|---|
| Base Insert % | 16% | 11% | 11% |

With reference to Table 3 and Table 4 below, it may be advantageous to exclude the weight of the pedestal 20 from the total weight of the base assembly 12 because the height, weight, and volume of the pedestal 20 will fluctuate based on the height of the container being produced. With reference to Table 3, depending on the capacity of the container and the materials used, the weight of the base assembly 12 excluding pedestal 20 can be between 2.4 and 18.6 pounds, and the weight of the base insert 80 can be between 0.7 and 4.1 pounds. With reference to Table 4, depending on the capacity of the container, the volume of the base assembly 12 excluding the pedestal 20 can be between 19.4 and 51.2 cubic inches, and the volume of the base insert 80 can be between 7.1 and 14.2 cubic inches. Therefore, the volume of the base insert 80 is less than 40% of a total weight of the base assembly 12 excluding pedestal 20, or about 26-36% of a total weight of the base assembly 12 excluding pedestal 20.

TABLE 3

| | 10 oz Container | | 16 oz Container | | 32 oz Container | |
|---|---|---|---|---|---|---|
| Weight (lbs) | Aluminum | Stainless | Aluminum | Stainless | Aluminum | Stainless |
| Base Cup | 1.7(lbs.) | 4.9(lbs.) | 3.4(lbs.) | 9.7(lbs.) | 5.1(lbs.) | 14.6(lbs.) |
| Spacer | | | | | | |
| Guide Ring | | | | | | |
| C.S.R | | | | | | |
| Lock Ring | | | | | | |
| Base Insert | 0.7(lbs.) | 2.0(lbs.) | 0.9(lbs.) | 2.6(lbs.) | 1.4(lbs.) | 4.1(lbs.) |
| TOTAL WEIGHT | 2.4(lbs.) | 6.9(lbs.) | 4.3(lbs.) | 12.3(lbs.) | 6.5(lbs.) | 18.6(lbs.) |

TABLE 4

| | 10 oz | | 16 oz | | 32 oz | |
|---|---|---|---|---|---|---|
| | Container | | Container | | Container | |
| | Volume (in³) | | Volume (in³) | | Volume (in³) | |
| Base Cup | 12.3 | (in³) | 24.7 | (in³) | 37.0 | (in³) |
| Spacer | | | | | | |
| Guide Ring | | | | | | |
| C.S.R. | | | | | | |
| Lock Ring | | | | | | |
| Base Insert | 7.1 | (in³) | 8.9 | (in³) | 14.2 | (in³) |
| Total Volume | 19.4 | (in³) | 33.5 | (in³) | 51.2 | (in³) |

| | | | |
|---|---|---|---|
| Base Insert % | 36% | 26% | 28% |

Advantageously with the base assembly 12, to form the container base features only the base insert 80 weighing less than about 4 lbs. is actuated, which is in contrast to existing assemblies that must vertically actuate an entire base assembly weighing about 20 lbs. to 40 lbs., which can put a strain on the blow molding equipment and cause failures at higher blow molding speeds. The substantially lighter weight of the moveable base insert 80 enables the injection blow molding machine to operate at faster speeds to produce about 10% more containers per hour.

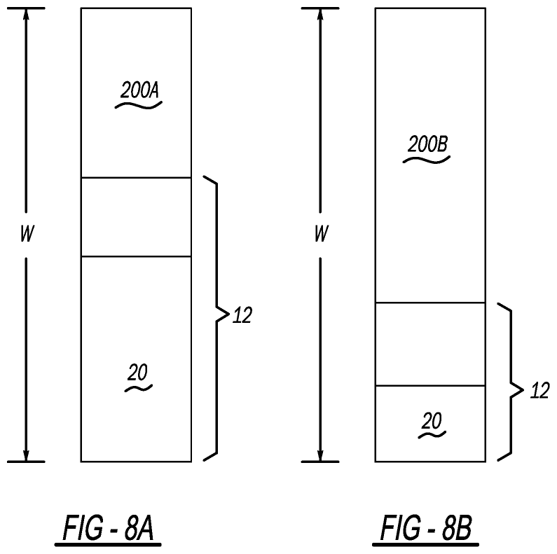

The overall height of the base assembly 12 is also shorter than existing assemblies, which allows for containers as much as 20% taller to be produced within molds that were previously restricted by the taller height of existing base tooling assemblies. For example, existing base assemblies may be about 244 mm tall as compared to the new base assembly 12, which can be about 196 mm tall. FIGS. 8A and 8B schematically illustrate the base assembly 12 and a mold window W, which identifies an area open to accepting a body assembly 200 of various different heights to form containers of different heights. In other words, the base assembly 12 is short enough that when installed in a molding machine the base assembly 12 provides for a mold window W that may accept a relatively short body assembly 200A with a taller pedestal 20 (see FIG. 8A) for forming a relatively short container. Alternatively, the mold window W may accept a relatively tall body assembly 200B with a shorter pedestal 20 (see FIG. 8B) for forming a relatively tall container. Existing base assemblies do not provide for such flexibility.

The base insert 80 is advantageously movable to actuate up and down during the blow molding process, which is known as “overstroke.” During the overstroke process, the preform is blown and stretched beyond a final base position when the base insert 80 is in the retracted position of FIG. 5. The base insert 80 is then moved to the extended position of FIG. 4 by pumping gas into the gaps 120. The overstroke process advantageously allows for complex geometrical designs to be formed with less material in the base of the polymeric container. The overstroke process also allows for improvements in material distribution and higher crystallinity suitable for passive and active vacuum absorbing base designs. However, any suitable base can be produced with the assembly 10 including rigid bases, petaloid bases, and champagne style bases. With the assembly 10 according to the present disclosure, the heel of the polymeric container is encapsulated within the body mold 210, and the body mold 210 includes a first internal flange 240, which is a horizontal parting line. The horizontal parting line of the present disclosure is in contrast to previous assemblies, which include a vertical parting line.

The assembly 10 further advantageously has provisions for both air cooling and oil cooling to improve the injection molding process. The quick change support post 22 is advantageously a quick-change post that allows the assembly to be installed in machines that typically can only accommodate non-removable assemblies.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A base assembly configured to cooperate with an injection blow molding machine for forming a polymeric container from a preform by injection blow molding, the base assembly comprising:
a base insert defining a base mold configured to form a base of the polymeric container during injection blow molding, the base insert slidably seated within the base assembly;
wherein the base insert is slidably movable between a retracted position and an extended position during injection blow molding of the polymeric container; and
wherein the base insert moves independent of the base assembly.

2. The base assembly of claim 1, wherein the base insert is moved pneumatically, hydraulically, or with a servo.

3. The base assembly of claim 1, wherein in the extended position a gap is defined beneath the base insert and filled with gas to maintain the base insert in the extended position.

4. The base assembly of claim 1, wherein:
the base assembly further comprises a guiding ring; and
the base insert is slidably seated within the guiding ring and movable independent of the guiding ring.

5. The base assembly of claim 4, wherein the guiding ring is supported by a pedestal.

6. The base assembly of claim 1, wherein a total volume of the base insert is less than about 20% of a total volume of the base assembly.

7. The base assembly of claim 1, wherein a total weight of the base insert is between about 11-16% of a total weight of the base assembly.

8. The base assembly of claim 1, wherein a total volume of the base insert is less than about 40% of a total volume of the base assembly excluding a pedestal of the base assembly.

9. The base assembly of claim 1, wherein a total weight of the base insert is between about 26-36% of a total weight of the base assembly excluding a pedestal of the base assembly.

10. The base assembly of claim 1, wherein a total weight of the base assembly is less than about 40 lbs., and the base insert weighs less than about 4 lbs.

11. The base assembly of claim 1, further comprising:
a guiding ring supported by a pedestal, the base insert is slidably seated within the guiding ring and movable independent of the guiding ring; and
a spacer between the pedestal and the guiding ring.

12. The base assembly of claim 11, further comprising an outer base cup located above the guiding ring, the base insert is slidably seated within the outer base cup;
wherein the base insert is slidably movable independent of the outer base cup and the guiding ring; and
wherein the outer base cup defines an annular inner curved surface configured to define a heel of the polymeric container during injection blow molding.

13. The base assembly of claim 12, wherein the outer base cup includes a lower cup flange configured to cooperate with a base insert flange of the base insert when the base insert is in the extended position to stop the base insert from moving outward beyond the extended position.

14. The base assembly of claim 12, wherein the outer base cup is mounted directly to the guiding ring.

15. The base assembly of claim 1, wherein the base assembly is configured to cooperate with a body mold, the body mold is configured to form a body of the polymeric container, the body mold includes a first half and a second half and defines an internal flange facing an upper surface of an outer base cup when the body mold is closed during injection blow molding; and
wherein the internal flange forms a horizontal mold parting line with the outer base cup extending perpendicular to a longitudinal axis of the base assembly passing through an axial center of the base insert.

16. The base assembly of claim 15, wherein the polymeric container has a capacity of 10 to 32 ounces.

17. The base assembly of claim 1, wherein the base insert defines a center aperture in which a counter stretch rod is inserted;
wherein the counter stretch rod is seated in a pedestal receptacle defined by a pedestal supporting the base insert; and
wherein the counter stretch rod is movable between a retracted position in which the counter stretch rod does not extend out from within the center aperture and an extended position in which the counter stretch rod extends outward from the center aperture beyond the base mold.

18. The base assembly of claim 17, wherein the counter stretch rod is moved pneumatically, hydraulically, or with a servo.

19. The base assembly of claim 1, further comprising a quick change support post extending from an undersurface of the base assembly, the quick change support post configured to cooperate with the injection blow molding machine to support the base assembly in the injection blow molding machine.

20. A base assembly configured to cooperate with an injection blow molding machine for forming a polymeric container from a preform by injection blow molding, the base assembly comprising:
a guiding ring configured to be supported by a pedestal; and
a base insert slidably seated within the guiding ring, the base insert defining a base mold configured to form a base of the polymeric container during injection blow molding;
an outer base cup arranged above the guiding ring, the base insert slidably seated within the outer base cup; and
wherein the base insert is slidably movable independent of the pedestal, and the guiding ring.

21. The base assembly of claim 20, wherein the base assembly is configured to cooperate with a body mold configured to form a body of the polymeric container, the body mold including a first half and a second half and defining an internal flange facing an upper surface of the outer base cup when the body mold is closed during injection blow molding, the internal flange is a horizontal mold parting line extending perpendicular to a longitudinal axis of the base assembly passing through an axial center of the base insert and the outer base cup; and
wherein the base insert is slidably movable independent of the outer base cup.

22. The base assembly of claim 21, further comprising a spacer between the pedestal and the guiding ring, a gap is defined between the spacer, the guiding ring, and the base insert; and
wherein the base insert is slidably movable between a retracted position and an extended position during injection blow molding of the polymeric container, in the extended position the gap is defined beneath the base insert and filled with gas to maintain the base insert in the extended position.

23. The base assembly of claim 22, wherein the outer base cup includes a lower cup flange configured to cooperate with a base insert flange of the base insert when the base insert is in the extended position to stop the base insert from moving outward beyond the extended position; and
wherein the outer base cup is seated directly on the guiding ring.

24. The base assembly of claim 21, further comprising a locking ring mounted to the pedestal, the locking ring configured to cooperate with the body mold when the body mold is closed during injection blow molding.

25. The base assembly of claim 20, further comprising a quick change support post extending from an undersurface of the base assembly, the quick change support post configured to cooperate with the injection blow molding machine to support the base assembly in the injection blow molding machine.

26. The base assembly of claim 20, wherein the outer base cup defines an annular inner curved surface configured to define a heel of the polymeric container during injection blow molding.
